(19) United States
(12) Patent Application Publication
(10) Pub. No.: US 2023/0384800 A1
(43) Pub. Date: Nov. 30, 2023

(54) POWER LINE STRINGING SYSTEM AND METHOD

(71) Applicant: INFRAVISION HOLDINGS PTY LTD, New South Wales (AU)

(72) Inventors: Cameron Van Der Berg, New South Wales (AU); Daniel Van Der Berg

(21) Appl. No.: 18/027,976

(22) PCT Filed: Sep. 23, 2021
(86) PCT No.: PCT/AU2021/051115

§ 371 Date: Mar. 23, 2023

(30) Foreign Application Priority Data
Sep. 24, 2020 (AU) 2020903435
Jul. 30, 2021 (AU) 2021902353
Aug. 24, 2021 (AU) 2021106947

(51) Int. Cl. G05D 1/10; G05D 1/00

(52) U.S. Cl. CPC G05D 1/101; G05D 1/0022; G05D 1/0088

(57) ABSTRACT

A method for installing a line on a series of transmission towers is provided. A mobile winch (100) is provided with a first and second line sections (200, 202). The UAS (300) and mobile winch (100) are operated to deliver and install the first line section (200) to a first plurality of transmission towers (700) until the UAS reaches a second staging point. The mobile winch (100) and UAS (300) are moved to a further staging point, spaced from the second staging point by a further plurality of the transmission towers (702). The UAS (300) and mobile winch (100) are operated to deliver and install the second line section (202) to a further plurality of transmission towers (702) until the UAS reaches the second staging point. Finally, the first line section (200) is connected to the second line section (202).

### CROSS-REFERENCE TO RELATED APPLICATION

The present application is related to Australian Provisional Patent Application No. 2020903435, entitled “Power line stringing system and method” and filed on 24 Sep. 2020 in the name of Infravision Holdings Pty Ltd and Australian Provisional Patent Application No. 2021902353, entitled “Line attachment device” and filed on 30 Jul. 2021 in the name of Infravision Holdings Pty Ltd, the entire content of each of which is incorporated herein by reference as if fully set forth herewith.

### TECHNICAL FIELD

The present disclosure relates to a power line stringing system and method. In particular, the present invention relates to a system and method for installing high voltage power line cables on transmission towers.

### BACKGROUND OF THE INVENTION

Stringing high voltage power lines to transmission towers is a difficult, dangerous, and time consuming operation involving helicopters, cable winches, and a large work force of dozens of workers in the field, some of them very highly skilled, such as helicopter pilots and the helicopter crews.

Using helicopters in close proximity to transmission towers is inherently very dangerous as sudden wind gusts can cause accidents with catastrophic consequences. The resources required and cost to conduct such an operation are also immense due to the total number of man hours needed, the high levels of expertise required, the running costs for the helicopter and other equipment, the safety requirements, etc. Helicopters have traditionally been required to perform the power line stringing operation because of the weight of the power line cables, which require powerful aircraft to lift the cables and the ability to hover over the transmission tower while the cable is installed.

However, due to safety concerns, helicopters can only be operated during favourable weather conditions. Even so, due to the dangerous nature of operating a helicopter near transmission towers, accidents happen frequently and insurance for such practices is difficult to obtain and prohibitively expensive. The dozens of highly skilled workers required to perform such an operation is also a significant expense and can impair operations if the required personnel are not available.

It is therefore desirable to provide a safer and more efficient system and method for installing high voltage power line cables on transmission towers.

### OBJECT OF THE INVENTION

It is an object of the present invention to substantially overcome or at least ameliorate one or more of the above disadvantages, to meet the above desire, or to provide a useful alternative to the prior art.

### SUMMARY OF THE INVENTION

In a first aspect, the present disclosure provides a method for installing power line cables on transmission towers, the method comprising:
providing at a first staging point a first line section of said line spooled at a first end on a mobile winch and attached at a second end to an Unmanned Aircraft System (UAS);
operating the UAS and mobile winch to pay out the first line section and deliver the second end of the first line section sequentially to each of a first plurality of said series of transmission towers and to thread or otherwise attach the first line section onto a support of each transmission tower until the UAS reaches a second staging point;
detaching the first end of the first line section from the mobile winch and attaching it to a first anchor at the first staging point and detaching the second end of the first line section from the UAS and securing it to a second anchor at the second staging point;
moving the mobile winch and UAS to a further staging point, spaced from the second staging point by a further plurality of said series of transmission towers, and loading a first end of a second line section of said line onto the mobile winch and attaching a second end of the second line section to the UAS;
operating the UAS and mobile winch to pay out the second line section and deliver the second end of the second line section sequentially to each of the further plurality of transmission towers and to thread or otherwise attach the second line section onto a support of each transmission tower until the UAS reaches the second staging point;
connecting the second end of the first line section to the second end of the second line section.

Optionally, the method further comprises repeating the steps of moving the mobile winch and UAS to a further staging point and operating the UAS and mobile winch to deliver a further line section to a further plurality of transmission towers until the entire series of transmission towers is connected sequentially by the line.

In a preferred embodiment, the method further comprises:
connecting an end of the line to a power line cable; and
operating the mobile winch to wind in the line, thereby drawing the power line cable in place of the line.

In another preferred embodiment, the method further comprises:
connecting an end of the line to a secondary line;
operating the mobile winch to wind in the line, thereby drawing the secondary line in place of the line;
connecting an end of the secondary line to a power line cable; and
operating the mobile winch to wind in the secondary line, thereby drawing the power line cable in place of the secondary line.

In a preferred embodiment, the method further comprises varying the speed at which the line is deployed from the mobile winch during operation of the UAS in order to control and maintain a relatively constant tension on the line.

In a second aspect, the present disclosure provides a transmission tower line attachment device for attaching to a transmission tower, the attachment device comprising:
a first guide arm;
an upper frame spaced from the first guide arm and defining a throat between the first guide arm and the upper frame;
a resilient first gate arranged at an outer end of the upper frame between the upper frame and the first guide arm and adapted to open inwardly into the throat in response to an external force and to close when the external force is removed;
wherein the attachment mechanism is adapted to be mounted adjacent to a hanging sheave of the transmission tower at an inner end of the upper frame and first guide arm.

Preferably, the line attachment device further comprises a second gate arranged at an inner end of the upper frame, the second gate being adapted to open inwardly in response to an external force.

Further preferably, the second gate is held closed by a frangible link.

Preferably, the resilient first gate is spring mounted to the upper frame.

Preferably, the line attachment device further comprises a second guide arm projecting upwardly from the upper frame.

In a third aspect, the present disclosure provides a hanging sheave arrangement for a transmission tower, the hanging sheave arrangement comprising:
an aperture above a hanging sheave for housing at least one power line, the aperture being accessible via a first gate;
a first guide arm extending outwardly and upwardly from adjacent the first gate;
an upper frame spaced from the first guide arm and defining a throat extending from the first gate between the first guide arm and the upper frame; and
a resilient second gate arranged at an outer end of the upper frame between the upper frame and the first guide arm and adapted to open inwardly into the throat in response to an external force and to close when the external force is removed.

Preferably, the resilient second gate is spring mounted to the upper frame.

Preferably, the hanging sheave arrangement further comprises a second guide arm projecting upwardly from the upper frame.

### BRIEF DESCRIPTION OF THE DRAWINGS

A preferred embodiment of the invention will now be described by way of specific example with reference to the accompanying drawings, in which:

FIG. 1 depicts a first stage of a first system and method for installing high voltage power line cables on transmission towers;

FIG. 2 depicts a second stage of the system and method of FIG. 1;

FIG. 3 depicts a first stage of a second system and method for installing high voltage power line cables on transmission towers;

FIG. 4 depicts a second stage of the system and method of FIG. 3;

FIG. 5 depicts a third stage of the system and method of FIG. 3;

FIG. 6 depicts a fourth stage of the system and method of FIG. 3;

FIG. 7 depicts a first stage of a second system and method for installing high voltage power line cables on transmission towers;

FIG. 8 depicts a second stage of the system and method of FIG. 7;

FIG. 9 depicts a first stage of a third system and method for installing high voltage power line cables on transmission towers;

FIG. 10 depicts a second stage of the system and method of FIG. 9;

FIG. 11 depicts the step of installing the primary line on the transmission tower;

FIG. 12 depicts a hanging sheave of the transmission tower; and

FIGS. 13 to 16 depict an alternative embodiment of an attachment device and hanging sheave showing different stages of the process of installing a line on the hanging sheave.

### DETAILED DESCRIPTION OF THE PREFERRED EMBODIMENTS

The present disclosure provides a system and method for installing high voltage power line cables on transmission towers. The system and method uses an Unmanned Aircraft System (UAS) to deploy a primary line from a cable winch onto the transmission towers, before the primary line is used to draw the power line cable onto the transmission towers using the cable winch. In a preferred procedure, a heavier secondary line is drawn onto the transmission towers by the primary line, before the secondary line is then used to draw the power line cable onto the transmission towers.

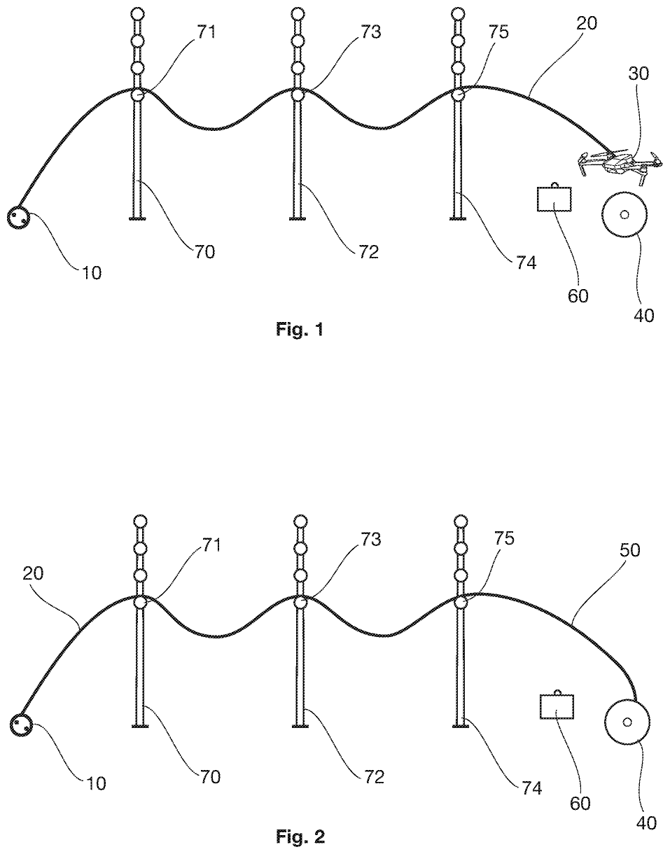

In the embodiment depicted in FIGS. 1 and 2, the system includes a primary winch 10, having a primary line 20 spooled on the primary winch 10, an Unmanned Aircraft System (UAS) 30, a secondary winch 40, having a power line cable 50 spooled on the secondary winch 40, and an anchor 60. The system is used to install high voltage powerline cables across a series of transmission towers 70, 72, 74.

The free end of the primary line 20 is connected to the UAS 30 and the UAS 30 is operated to deliver the primary line 20 to the first transmission tower 70, as the primary winch 10 gradually pays out the primary line 20. By careful operation of the UAS 30, the primary line 20 is slotted into a hanging sheave 71 of the first transmission tower 70, before the UAS 30 delivers the free end of the primary line 20 to the second transmission tower 72. This process is repeated in order to slot the primary line 20 into the hanging sheave 73 of the second transmission tower 72 and subsequently, the hanging sheave 75 of the third transmission tower 74. This process may be repeated for as many transmission towers as is desired.

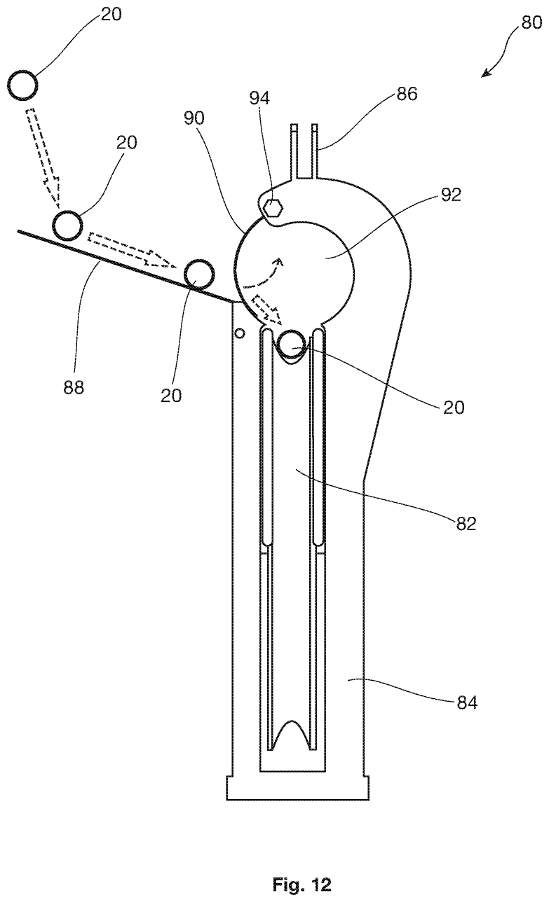

An embodiment of a suitable hanging sheave 80 is depicted in detail in FIG. 12. The hanging sheave 80 comprises a pulley wheel 82 mounted to a block 84 that is attached to the transmission tower by a bracket 86. A line guide 88 projects laterally and upwardly from the block 84 near the top of the pulley wheel 82. A spring-loaded, pivotable gate 90 is mounted on the block 84 adjacent to the line guide 88 and provides access to an aperture 92 in the block 84 above the pulley wheel 82 by pivoting inwardly from a pivot mounting 94 at the top of the block 84. The gate 90 has a curved cross-sectional profile, curving downwardly and inwardly of the block 84.

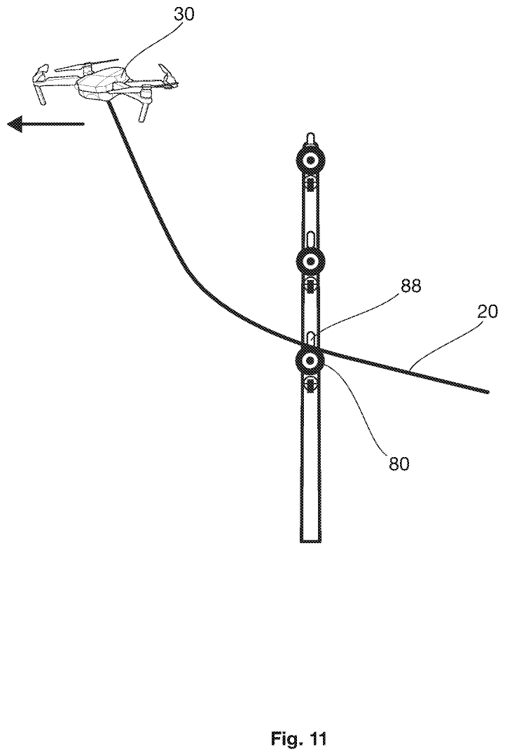

In order to slot the primary line 20 carried by the UAS 30 into the hanging sheave 80, the UAS 30 is operated as shown in FIG. 11 to draw the primary line 20 over the line guide 88 and then to lower the primary line 20 onto the line guide 88 as shown in FIG. 12. As the UAS 30 lowers the primary line 20, the slope of the line guide 88 draws the primary line 20 towards the gate 90, which opens by resiliently pivoting inwardly (as shown by the curved arrow in FIG. 12) and then snaps back to the closed position once the primary line 20 has passed into the aperture 92. The primary line 20 is then contained within the aperture 92 of the hanging sheave 80 on top of the pulley wheel 82. The curved profile of the gate 90 helps to prevent the primary line 20 from snagging on the gate 90 as it enters the aperture 92.

One hanging sheave 80 is required for each conductor supported by the transmission tower. When slotting the primary line 20 into a hanging sheave 80, the UAS 30 follows a pre-planned, automated flight profile to align the primary line 20 with the hanging sheave 80. The UAS 30 is then ‘bumped’ by the operator to make any final adjustments necessary to land the primary line 20 on the line guide 88 of the hanging sheave 80.

During the primary line delivery and slotting operation, the payout speed of the primary winch 10 is controlled to maintain a relatively constant tension on the primary line 20 by varying the speed at which the primary line 20 is deployed from the primary winch 10. This helps to avoid the primary line 20 being snagged or entangled in forestry and allows for efficient operation of the UAS 30.

Returning to FIGS. 1 and 2, once the primary line 20 has been slotted into the hanging sheaves 71, 73, 75 of the transmission towers 70, 72, 74, the free end of the primary line 20 is secured to the anchor 60. While anchored, the free end of the primary line 20 is connected to the end of the heavier power line cable 50 that is spooled on the secondary winch 40. Once connected to the power line cable 50, the primary line 20 is disconnected from the anchor 60.

The primary winch 10 is then operated in retrieval mode to wind in the primary line 20, while the secondary winch 40 allows the power line cable 50 to be paid out. This draws the power line cable 50 along the path of the primary line 20, thereby replacing the primary line 20 across the transmission towers 70, 72, 74 with the power line cable 50.

In each operation, the weight of primary line 20 will be limited by the capacity of the UAS 30 to carry the desired length of primary line 20. This will often result in the weight of the primary line 20 being insufficient to connect directly to the much heavier power line cable 50. In that instance, the secondary winch 40 is used to deliver a heavier secondary line onto the transmission towers 70, 72, 74, which is subsequently replaced by the power line cable 50 in the same manner.

The limited capacity of the UAS to carry a certain weight of line and the battery range of the UAS will also limit the range of the UAS while carrying a line and how many transmission towers the line can be installed on in one sequence.

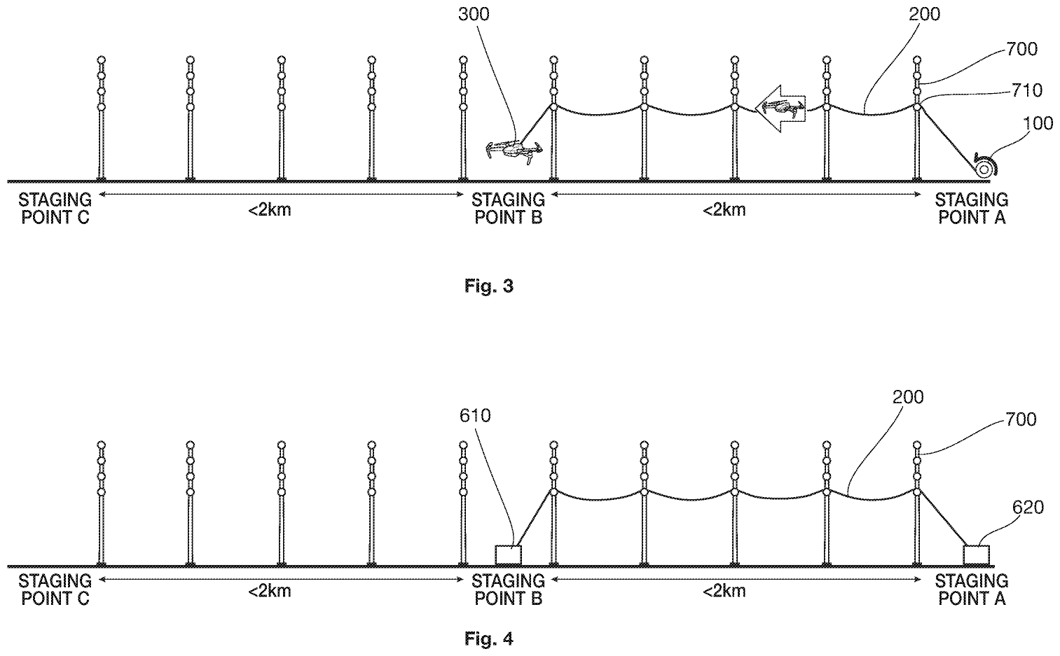

FIGS. 3 to 6 depict an embodiment of the method that resolves this issue and minimises the required equipment and man hours for installing the line across a given span of transmission towers.

The mobile winch 100 is arranged at one end of the sequence of transmission towers 700, at Staging Point A in FIG. 3. A 6 mm first line section 200 is spooled on the mobile winch 100 for pay out by the mobile winch 100. By way of example, the first line section 200 may be 2 km long.

A free end of the first line section 200 at Staging Point A is attached to the UAS 300, which is then operated to deliver the first line section 200, via each intervening transmission tower 700, to Staging Point B at the end of the sequence of the first plurality of transmission towers 700. At each transmission tower 700, the first line section 200 is slotted by operation of the UAS 300 into a hanging sheave 710 of the transmission tower 700, before moving on to the next transmission tower 700. When the UAS 300 arrives at Staging Point B, the free end of the first line section 200 is detached from the UAS and secured to a first anchor 610. After tightening the line the opposite end of the first line section 200 is similarly detached from the mobile winch 100 and secured to a second anchor 620. This stage is depicted in FIG. 4.

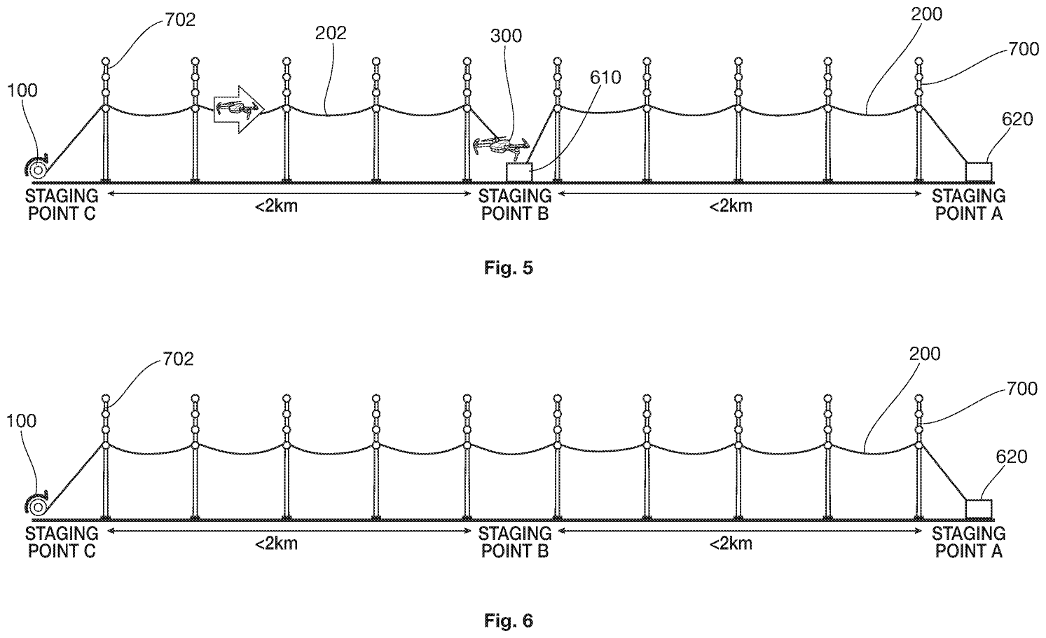

The mobile winch 100 and UAS 300 are then transported to Staging Point C. Here, as depicted in FIG. 5, a free end of a second line section 202, now spooled on the mobile winch 100, is attached to the UAS 300. The UAS 300 is then operated to deliver the second line section 202, via each intervening transmission tower 702, to Staging Point B at the end of the sequence of the second plurality of transmission towers 702. When the UAS 300 arrives at Staging Point B, the free end of the second line section 202 is detached from the UAS 300 and secured to the end of the first line section 200. The mobile winch 100 can then be operated to draw the first and second line sections 200, 202 taught, as depicted in FIG. 6. In the same way, further line sections of 2 km can be added to the end of the line by repeatedly moving the mobile winch 100 and UAS 300 a further 2 km along the series of transmission towers and installing a further 2 km line section back to the end of the already installed line.

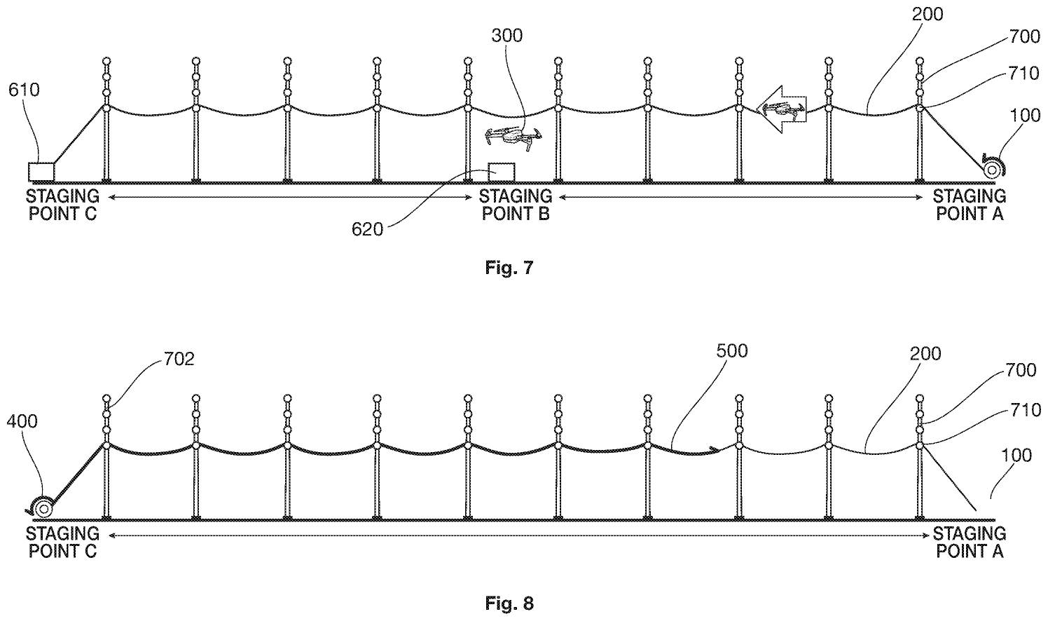

A further embodiment is depicted in FIGS. 7 and 8, in which the primary winch 100 is arranged at one end of the sequence of transmission towers 700, at Staging Point A in FIG. 7. A 6 mm primary line 200 is spooled for pay out by the primary winch 100. By way of example, the primary line 200 may be 4 km long.

A free end of the primary line 200 at Staging Point A is attached to the UAS 300, which is then operated to deliver the primary line 200, via each intervening transmission tower 700, to Staging Point C at the other end of the sequence of transmission towers 700. At each transmission tower 700, the primary line 200 is slotted by operation of the UAS 300 into a hanging sheave 710 of the transmission tower 700, before moving on to the next transmission tower 700. When the UAS 300 arrives at Staging Point C, the free end of the primary line 200 is secured to a first anchor 610.

Depending on the range and power of the UAS 300, it may not be possible for the UAS 300 complete the delivery from Staging Point A to Staging Point C in one uninterrupted operation. In such circumstances, it may be necessary to anchor the primary line 200 to a second anchor 620 at an intermediate Staging Point B. This will allow the UAS 300 to be recharged or replaced, so that the operation can then continue to Staging Point C. In the present example, the UAS 300 only has a range of 2 km, so an intermediate Staging Point B is required to complete a 4 km sequence of transmission towers 700.

During the operation of the UAS 300, the payout speed of the primary winch 100 is controlled to maintain a relatively constant tension on the primary line 200 of around 500 N by varying the speed at which the primary line 200 is deployed from the primary winch 100. This helps to avoid the primary line 200 being snagged or entangled in forestry and allows for efficient operation of the UAS 300.

The UAS 300 then returns to Staging Point A or is recovered at Staging Point C and the primary winch 100 is used to partially wind in the primary line 200 to increase the tension in the primary line 200 to around 5000 N. This helps prevent excessive sag occurring at any single span between transmission towers 700 due to localised high wind.

Turning to FIG. 8, a secondary winch 400 with a heavier 12 mm secondary line 500 is delivered to Staging Point C. The anchored end of the primary line 200 is connected to the free end of the secondary line 500 spooled on the secondary winch 400 at Staging Point C.

The primary winch 100 and secondary winch 400 are then operated in tandem to wind the primary line 200 onto the primary winch 100, while paying out the secondary line 500, maintaining a tension of around 5000 N. This draws the secondary line 500 along the path of the primary line 200 across each of the hanging sheaves 710 and onto the transmission towers 700.

A similar operation can then be performed to install the power line cable by attaching the power line cable to one end of the secondary line 500 and winding in the secondary line 500 back onto the secondary winch 400.

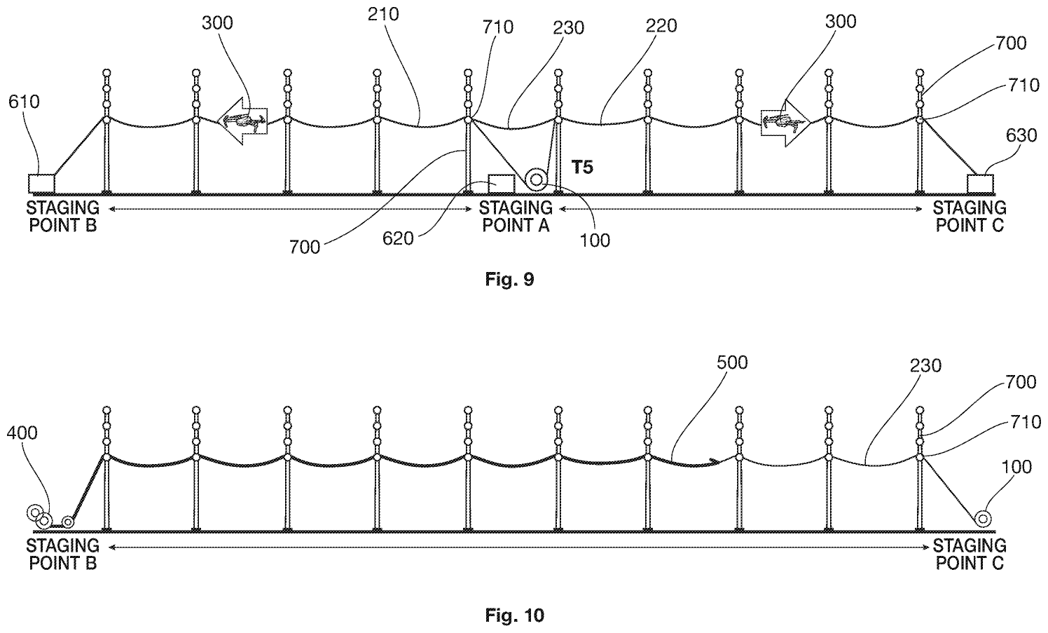

In another embodiment, depicted in FIGS. 9 and 10, the primary winch 100 is arranged near the centre of the sequence of transmission towers 700, at Staging Point A in FIG. 9. Two lengths of a 6 mm primary line 210, 220 are spooled for pay out by the primary winch 100. By way of example, for a 4 km sequence of transmission towers 700, each primary line 210, 220 would need to be at least 2 km long.

A free end of a first primary line 210 is attached to the UAS 300, which is then operated to deliver the first primary line 210, via each intervening transmission tower 700, to Staging Point B at one end of the sequence of transmission towers 700. At each transmission tower 700, the first primary line 210 is slotted by operation of the UAS 300 into a hanging sheave 710 of the transmission tower 700, before moving on to the next transmission tower 700. When the UAS 300 arrives at Staging Point B, the free end of the first primary line 210 is secured to a first anchor 610.

During this operation, the payout speed of the primary winch 100 is controlled to maintain a relatively constant tension on the first primary line 210 of around 500 N by varying the speed at which the first primary line 210 is deployed from the primary winch 100. This helps to avoid the first primary line 210 being snagged or entangled in forestry and allows for efficient operation of the UAS 300.

The UAS 300 then returns to Staging Point A and the primary winch 100 is used to partially wind in the first primary line 210 to increase the tension in the first primary line 210 to around 5000 N. This helps prevent excessive sag occurring at any single span between transmission towers 700 due to localised high wind. The first primary line 210 can then be cut and anchored to a second anchor 620 at Staging Point A.

Next, a free end of a second primary line 220 is attached to the UAS 300, which is then operated to deliver the second primary line 220, via each intervening transmission tower 700, to Staging Point C at the other end of the sequence of transmission towers 700. At each transmission tower 700, the second primary line 220 is slotted by operation of the UAS 300 into a hanging sheave 710 of the transmission tower 700, before moving on to the next transmission tower 700. When the UAS 300 arrives at Staging Point C, the free end of the second primary line 220 is secured to a third anchor 630.

During this operation, the payout speed of the primary winch 100 is controlled to maintain a relatively constant tension on the second primary line 220 of around 500 N by varying the speed at which the second primary line 220 is deployed from the primary winch 100. This helps to avoid the second primary line 220 being snagged or entangled in forestry and allows for efficient operation of the UAS 300.

The UAS 300 then returns to Staging Point A or can be collected at Staging Point C. The primary winch 100 is used to partially wind in the second primary line 220 to increase the tension in the second primary line 220 to around 5000 N. This helps prevent excessive sag occurring at any single span between transmission towers 700 due to localised high wind.

The second primary line 220 can then be cut from the primary winch 100 and joined to the anchored end of the first primary line 210 to form a continuous combined primary line 230 extending from Staging Point B to Staging Point C. The primary winch 100 and the second anchor 620 can then be removed from Staging Point A.

A secondary winch 400 with a heavier 12 mm secondary line 500 is delivered to Staging Point B and the primary winch 100 is delivered to Staging Point C. The combined primary line 230 is connected at Staging Point C to the empty spool of the primary winch 100 and at Staging Point B to the free end of the secondary line 500 spooled on the secondary winch 400.

The primary winch 100 and secondary winch 400 are then operated in tandem to wind the combined primary line 230 onto the primary winch 100, while paying out the secondary line 500, maintaining a tension of around 5000 N. This draws the secondary line 500 along the path of the combined primary line 230 and onto the transmission towers 700.

A similar operation can then be performed to install the power line cable by attaching the power line cable to one end of the secondary line 500 and winding in the secondary line 500.

The methods of the present disclosure allow a power line cable to be installed across a sequence of transmission towers by the operation of a UAS rather than a helicopter. This greatly simplifies the cable stringing operation and required far fewer resources to accomplish the same end. These methods are also less dangerous than traditional methods and require fewer personnel to operate. All of this results in a much more cost effective, efficient, and safer operation.

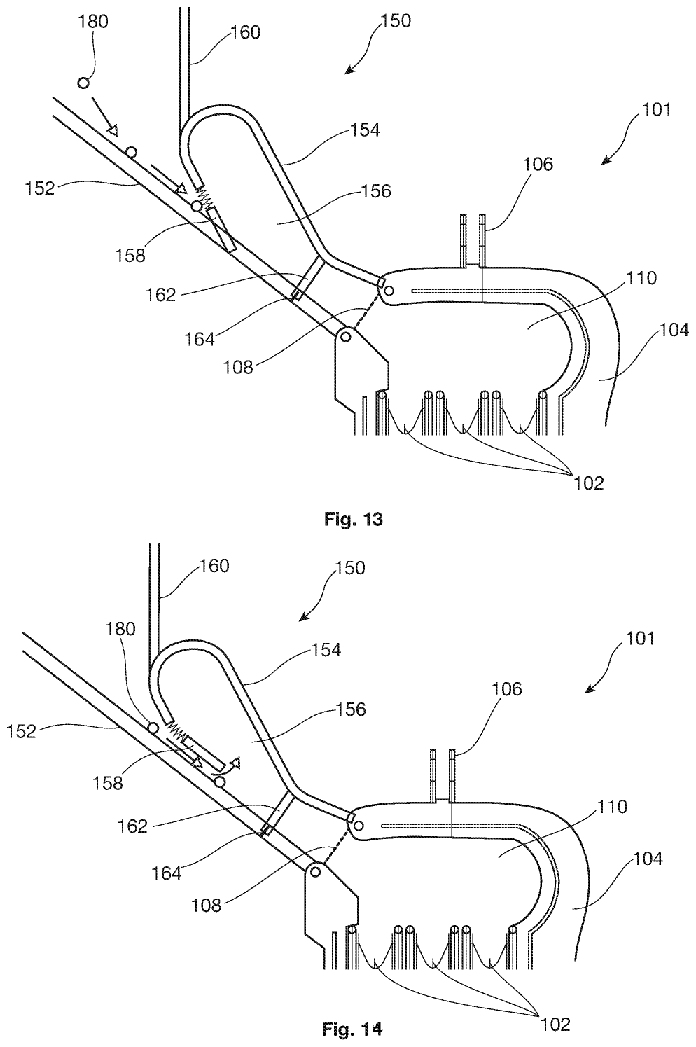

An alternative embodiment of a line attachment device 150 arranged on a traditional hanging sheave 101 is depicted in FIGS. 13 to 16. The hanging sheave 101 comprises a series of pulley wheels 102 mounted to a block 104 that is attached to the transmission tower by a bracket 106. The block 104 defines an aperture 110 above the pulley wheels 102 that is accessible via a spring-loaded sheave gate 108.

The line attachment device 150 is mounted to the hanging sheave 101 at attachment points 112 above and below the sheave gate 108. The line attachment device 150 comprises a laterally extending first guide arm 152 that projects laterally and upwardly from the block 104 near the bottom of the sheave gate 108. An upper frame 154 of the line attachment device 150 extends from the block 104 near the top of the sheave gate 108, defining an enclosed throat 156 between the upper frame 154 and the first guide arm 152.

A spring-mounted first gate 158 extends between the upper frame 154 and the first guide arm 152. In the embodiment depicted, the first gate 158 meets the first guide arm 152 at an oblique angle such that the first gate 158 can only open inwardly. It is envisaged that the first gate 158 could be embodied by many different gate mechanisms and any gate mechanism that can open inwardly due to external pressure and is prevented from opening due to internal pressure would suffice. A second guide arm 160 projects vertically from the upper frame 154 from above the first gate 158.

A second gate 162 extends between the upper frame 154 and the first guide arm 152, proximal to the sheave gate 108, and encloses the throat 156 at its lower end. In the embodiment depicted, the second gate 162 is held in the closed position, shown in FIG. 13, by a frangible link 164, such as a cable tie. It is envisaged that other frangible or force sensitive mechanisms could be used, such as spring mechanisms, to hold the second gate 162 in the closed position.

In order to slot the line 180 carried by an aerial vehicle 30 into the hanging sheave 101, the aerial vehicle 30 is operated to draw the line 180 over the guide arm 152 and then to lower the line 180 onto the guide arm 152 as shown in FIG. 13. As the aerial vehicle 30 lowers the line 180, the slope of the guide arm 152 draws the line 180 towards the first gate 158. The second guide arm 160 prevents the line 180 from being pulled over the top of the upper frame 154 and helps funnel the line 180 downwardly towards the first gate 154.

When the line 180 is drawn against the first gate 158, the first gate 158 opens by resiliently pivoting inwardly, as shown in FIG. 14, and then snaps back to the closed position once the line 180 has passed into the throat 156. The line 180 is then contained within the throat 156 and the second gate 162 is held in the closed position, keeping the line 180 contained within the throat 156, as shown in FIG. 14. With the line 180 contained within the throat, the aerial vehicle 30 can continue on and slot the line 180 into the throat 156 of the attachment device 150 on multiple successive transmission towers.

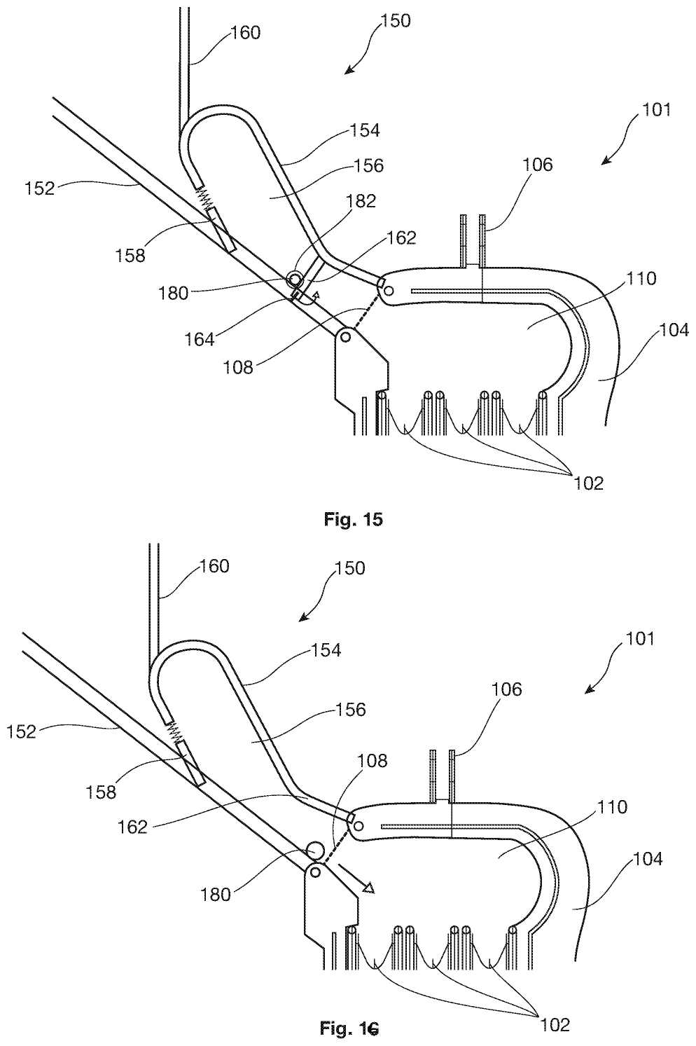

Once the line 180 is installed across a series of transmission towers in this manner, the line 180 can be replaced by a transmission cable 182, or a heavier gauge line as an intermediate step before replacing that with a transmission cable 182. This is done by attaching a heavier gauge line or cable 182 to one end of the line 180 and drawing it onto the transmission towers by winding in the line 180 from the other end. In this case, the original lighter line 180, acts as a pilot line that is then used to draw a heavier line or cable 182 onto the transmission towers. This is indicated in FIG. 15 by the larger diameter cable 182 shown in phantom around the line 180.

Once the cable 182 is installed, the cable 182 can then be drawn taught. This has the effect of drawing the cable 182 forcefully against the second gate 162, as depicted in FIG. 15. Pressure from the tension in the cable 182 as it is drawn taught is sufficient to break the frangible link 164 and allow the cable 182 to pass through the second gate 162. Further tightening of the cable 182 will then draw the cable 182 inwardly and downwardly through the sheave gate 108 and into the aperture 110 of the hanging sheave 101, where the cable 182 can slot into one of the pulley wheels 102.

Although the invention has been described with reference to specific examples, it will be appreciated by those skilled in the art that the invention may be embodied in many other forms.

1. A transmission tower line attachment device for attaching to a sheave block of a transmission tower, the sheave block having at least one sheave, a block body substantially enclosing a space above the sheave, and an aperture allowing access to the space above the sheave, the attachment device comprising:
a first guide arm having an inner end mountable to the block body adjacent to the aperture;
an upper frame having an inner end mountable to the block body so as to be spaced across the aperture from the first guide arm and defining a throat external to the block body between the first guide arm and the upper frame; and
a resilient first gate arranged at an outer end of the upper frame, distal from the inner end, between the upper frame and the first guide arm and adapted to open inwardly into the throat in response to an external force and to close when the external force is removed.

2. The line attachment device of claim 1, further comprising:
a second gate arranged at the inner end of the upper frame external to, and spaced from, the block body, the second gate being adapted to open inwardly towards the block body in response to an external force.

3. The line attachment device of claim 2, wherein the second gate is held closed by a frangible link.

4. The line attachment device of claim 1, wherein the resilient first gate is spring mounted to the upper frame.

5. The line attachment device of claim 1, further comprising a second guide arm projecting upwardly from the upper frame.

6. A hanging sheave arrangement for a transmission tower, the hanging sheave arrangement comprising:
at least one sheave, a block body substantially enclosing a space above the sheave, and an aperture allowing access to the space above the sheave, the aperture being closable by an inner gate mounted on the block body;
a first guide arm extending outwardly and upwardly from the block body adjacent the inner gate;
an upper frame connected at an inner end to the block body and spaced across the aperture from the first guide arm, the upper frame defining a throat external to the block body extending from the inner gate between the first guide arm and the upper frame; and
a resilient outer gate arranged at an outer end of the upper frame, distal to the inner end and spaced away from the block body, the outer gate extending between the upper frame and the first guide arm and adapted to open inwardly into the throat in response to an external force and to close when the external force is removed.

7. The hanging sheave arrangement of claim 6, wherein the resilient outer gate is spring mounted to the upper frame.

8. The hanging sheave arrangement of claim 6, further comprising a second guide arm projecting upwardly from the upper frame.

9. A method for installing a line on a series of transmission towers, the method comprising:
providing at a first staging point a first line section of said line spooled at a first end on a mobile winch and attached at a second end to an Unmanned Aircraft System (UAS);
operating the UAS and mobile winch to pay out the first line section and deliver the second end of the first line section sequentially to each of a first plurality of said series of transmission towers and to thread or otherwise attach the first line section onto a support of each transmission tower until the UAS reaches a second staging point;
detaching the first end of the first line section from the mobile winch and attaching it to a first anchor at the first staging point and detaching the second end of the first line section from the UAS and securing it to a second anchor at the second staging point;
moving the mobile winch and UAS to a further staging point, spaced from the second staging point by a further plurality of said series of transmission towers, and loading a first end of a second line section of said line onto the mobile winch and attaching a second end of the second line section to the UAS;
operating the UAS and mobile winch to pay out the second line section and deliver the second end of the second line section sequentially to each of the further plurality of transmission towers and to thread or otherwise attach the second line section onto a support of each transmission tower until the UAS reaches the second staging point;
connecting the second end of the first line section to the second end of the second line section.
